(19) United States
(12) Patent Application Publication
(10) Pub. No.: US 2012/0124009 A1
(43) Pub. Date: May 17, 2012

(54) AUTOMATIC EXPIRATION OF DATA IN FILE SYSTEMS UNDER CERTAIN SCENARIOS

(75) Inventors: Marc Eshel, San Jose, CA (US); Kalyan Chakravarthy Gunda, Bangalore (IN); Vrishali D. Hajare, Gainesville, FL (US); Mehul M. Joshi, Bhayander West (IN); Manoj Premananand Naik, San Jose, CA (US); Renu Tewari, San Jose, CA (US)

(73) Assignee: INTERNATION BUSINESS MACHINES CORPORATION, Armonk, NY (US)

(21) Appl. No.: 12/945,063

(22) Filed: Nov. 12, 2010

(51) Int. Cl. G06F 17/30

(52) U.S. Cl. 707/689; 707/E17.005

(57) ABSTRACT

A system for ensuring data integrity, comprising a plurality of data servers configured in a GPFS configuration, the plurality of data servers comprising an application server comprising a application server fileset, a home server comprising a home server fileset and a gateway server comprising a gateway fileset, a connection monitor node (CMN) coupled to gateway server; and logic, executed by the CMN, for monitoring a connection between the home server and the application server; and if the connection is disconnected, executing logic for comparing a duration of the connection disconnect to a expiration timeout attribute corresponding to the application server fileset and if the duration exceeds the expiration timeout attribute, notifying the application server to set an expiration status attribute in the application fileset.

### FIELD OF DISCLOSURE

The claimed subject matter relates generally to data storage and, more specifically, to the improvement in the reliability of data retrieval during communication outages.

### SUMMARY

Panache is a scalable, high-performance, remote file data caching solution integrated with the General Parallel File System (GPFS) cluster file system. It leverages the inherent scalability of GPFS to provide a scalable, multi-node, consistent cache of data exported by a remote file system cluster. Panache exploits the soon-to-be standard parallel network file system (pNFS) protocol to move data in parallel from the remote file cluster. Furthermore, it provides a POSIX compliant file system interface making the cache completely transparent to applications. Panache can mask the fluctuating wide-area-network latencies and outages by supporting asynchronous and disconnected-mode operations. It allows concurrent updates to be made at the cache and at the remote cluster and synchronizes them by using conflict detection techniques to flag and handle conflicts. To maintain commercial viability. Panache relies on open standards for high-performance file serving and does not require any proprietary hardware or software to be deployed at the remote cluster. Panache is integrated with the GPFS cluster file system to leverage the inherent scalability of GPFS for a scalable caching solution. The remote data is accessed over NFS so that any remote server exporting data over NFS can be the caching target. To get better performance, Panache can switch to pNFS for data transfer if the remote system exports the data using pNFS. The Panache cache is visible to any file system client as a POSIX compliant file system—thus any file system client can browse the cache and access the data as if it was in a local file system. In addition, the cached data can be further exported via NFS to other clients that are not part of the Panache cluster. To mask network latency and outages, Panache supports asynchronous write operations and fully disconnected operations. Data and metadata writes are done locally at the cache and then asynchronously pushed to the remote site. Writes can be bunched together to improve performance and can be queued at the I/O nodes in case of intermittent network connectivity. This does result in the possibility of conflicts that are detected and flagged. As of now, Panache does not support automatic conflict resolution. To handle long term network outages, Panache also maintains minimal on-disk logging (instead of a full event log) to resynchronize the cache and the remote site.

Consumer applications access data from panache, and panache brings updates/changes made at home automatically to cache. As the Inventors herein have realized, if the network connection between panache and home is broken, obviously the data movement can't occur resulting files being out of sync with home. In this scenario, there is a business requirement that an application want to make sure that the data in panache is not out of sync for more than a period of time. There is currently no technology in current file systems to provide this capability of preventing data access after disconnection of panache from home.

Provided are techniques for ensuring data integrity, comprising a plurality of data servers, the plurality of data servers comprising an application server comprising a application server fileset, a home server comprising a home server fileset and a first gateway server comprising a gateway fileset; a connection monitor node (CMN) coupled to the first gateway server; and logic, executed by the CMN, for monitoring a connection between the home server and the application server and, if the connection is disconnected, executing logic for comparing a duration of the connection disconnect to a expiration timeout attribute corresponding to the application server fileset; and if the duration exceeds the expiration timeout attribute, notifying the application server to set an expiration status attribute in the application fileset.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a network architecture that may implement the claimed subject matter.

FIG. 2 is an example of fileset attributes, including an expiration timeout attribute and an expired file attribute that may implement the claimed subject matter.

FIG. 3 is a block diagram of a connection Monitor node that may implement aspects of the claimed subject matter.

FIG. 4 is a flowchart illustrating an example of a monitor connections process that may implement aspects of the claimed subject matter.

FIG. 5 is a flowchart illustrating an example of a check cluster process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One embodiment, in accordance with the claimed subject, is directed to a programmed method for improving reliability of data storage. The term “programmed method”, as used herein, is defined to mean one or more process steps that are presently performed; or, alternatively, one or more process steps that are enabled to be performed at a future point in time. The term ‘programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In short, new fileset attributes, i.e. a expiration timeout and an expiration status are added to file set attributes The administrator can set the expiration timeout variable to imply that data can't be out of sync beyond this time after data storage has been disconnected from a home cluster. After disconnection and beyond the timer defined, expiration status is set to FAIL and a client will fail access to data until it can validate the authenticity of the data. During the time of access failure, the data is not deleted but still in file storage. The access denial is done based on disconnection time. Each fileset in the file storage system file system can have a different expiration time.

For example in a Panache cluster, some or all the nodes in the cluster will have network connection to home cluster. These nodes are designated as gateway nodes. The gateway (GW) nodes are the nodes which are doing the data transfer/validation etc between home & Panache. When one of the gateway node detects that a network connection from panache cluster to home is broken, it tries to reconnect to home to make sure that the disconnection is not due to flaky or temporary network failure. Once the GW node determines that the disconnection is due to real network issue, it stamps a disconnection time. If there are multiple GW nodes, one of the GW node is made as lead GW node. That node will scan the filesets periodically and evaluates if the time since disconnection is past expiration time, if so it will send out a expiration time remote procedure call (RPC) to all nodes in the cluster (GW nodes and app nodes). Once the expiration RPC is received, each node will mark the expiration status attribute in the fileset to mark the fileset as expired.

Once a fileset is marked expired, all ops on any file belonging the fileset is failed thus preventing the application's access to data in panache, once expiration time is past since the network connection has been disconnected between Panache & home cluster.

The expiration RPC is sent as each fileset expires. As an optimization if multiple filesets expire within a grace period, all filesets are expired in the same RPC thus optimizing the RPC traffic. Also note that each fileset can belong to different home with different expiration time and with different state of network connection. The expiration of data is driven only to filesets that have been disconnected due to network issue between Panache & home or other condition like say GPFS on the home cluster being down or NFS server being down etc. So basically, any condition that prevents panache from revalidating the data in cache will result in disconnection and continued disconnection beyond the expiration time triggers expiration.

The GW nodes keeps monitoring the network connection to home in the background. Once the network connection is back, it will trigger resetting expiration of all filesets belonging to that home. Once expiration is reset all applications can access data in panache filesets without any failure. This is done automatically by lead GW node by sending the unexpire RPC to all nodes in the cluster. There are various failure cases, like a new node joining the cluster and trying to access the data after expiration time. All these cases are covered by forcing the first access to panache file to go to GW node, which will reply with valid data or a expired failure if data is expired. Another condition is that all GW nodes that have connection to home or down or network is down is cache cluster. All these conditions are treated as indication of communication failure between panache and home cluster and thus driving expiration once the expiration time is past. Similarly, once the communication between panache & home is restored, this is detected automatically and triggers unexpire RPC to all nodes re-establishing access to data as before. Note that when a app fails due to expiration timer being triggered, the data in panache is not deleted, the data is still intact only access is failed. Its not like invalidation of cache, where cache is emptied. Also note that some fileset could be expired while some fileset are not in expired state. The filesets that haven't expired will allow access to data as usual and only data access to expired filesets is prevented. To prevent access to data in expired panache fileset, all deache entries belonging to expired fileset are invalidated, forcing to drive lookup for any entry to the expired fileset. Note that expiration of data in essence is triggered due to network failure between panache & home. An “unexpiration” of data is triggered by re-establishing of network between panache & home. This can be extrapolated to driving expiration by triggering the timer based on network/communication/component failure at home or cache. Note that there is no data loss or performance impacts on accessing the data in the cache due to this expired/unexpired data.

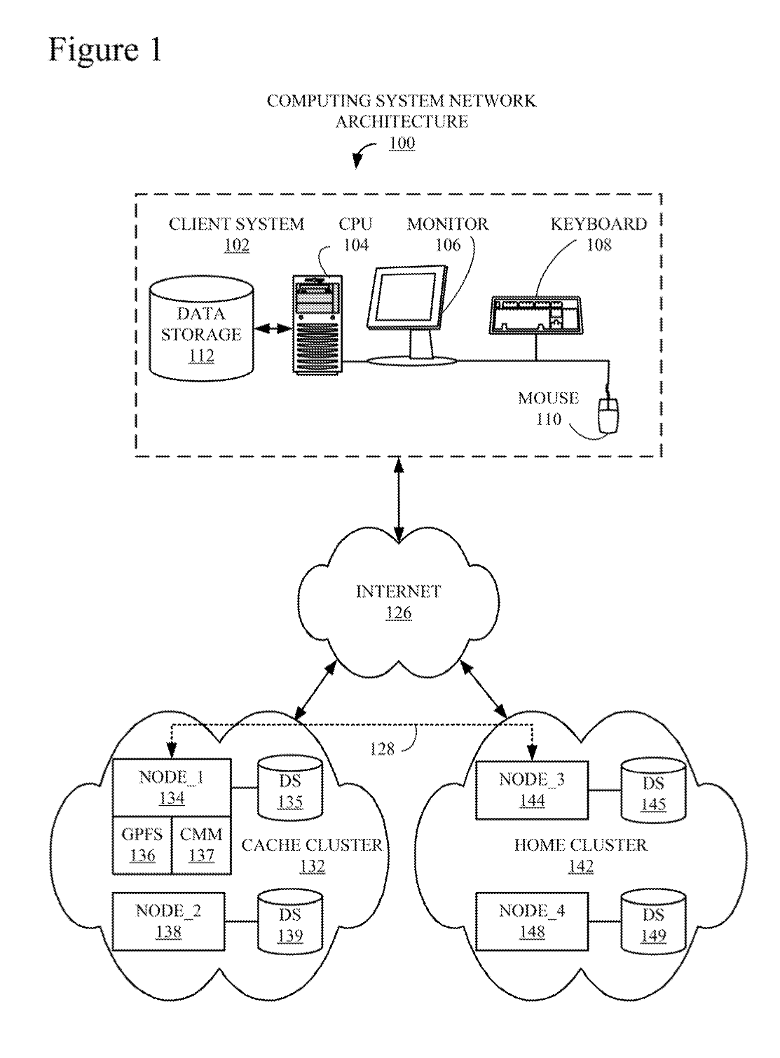

FIG. 1 is a computing system network architecture 100 that may implement the claimed subject matter. FIG. 1 includes a client system 102 as an example off device that may benefit form the disclosed technology. In this example computing system 102 attempts to access data stored on one of two clusters, i.e. a cache cluster 132 and a home cluster 142. Client system 102 and clusters 132 and 142 are connected via the Internet 126, although any networked configuration may be used.

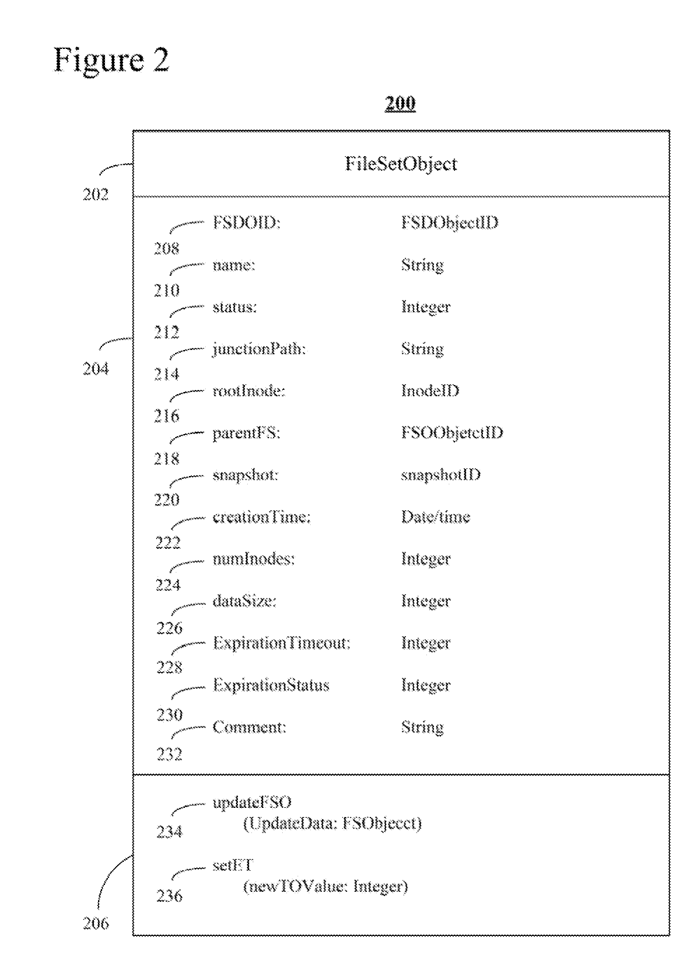

Cache cluster 132 includes a node_{—}1 134, coupled to a data storage (DS) 135, and a node_{—}2 138, coupled to a DS 139. Node_{—}1 134 includes logic for implementing a general parallel file system (GPFS) file configuration, or a GPFS module 136. In conjunction with GPFS 136, node_{—}1 134 has a connection monitor module (CMM) 137 that implements aspects of the claimed subject matter and is explained in detail below in conjunction with FIGS. 2-4. Home cluster 142 includes a node_{—}3 144, coupled to a DS 145, and a node_{—}4 148, coupled to a DS 149. Clusters 132 and 142 are configured in a general parallel file system (GPFS) configuration with enhancements explained below in conjunction with FIGS. 2-4. Although not shown any of nodes 138, 144 and 148 may also include GPFS and CMM modules. It should be also noted that clusters 132 and 142 may each include more than two nodes but for the sake of simplicity only nodes 134, 136, 144 and 146 are illustrated. In addition, any particular mode may be coupled to multiple data storage devices.

In this example, a dotted line between node_{—}1 134 in cache cluster 132 and node_{—}3 144 in home cluster 142 indicates that node_{—}1 132 maintains a network connection 128 with node_{—}3 144. Some or all nodes of cache 132 may maintain network connections with nodes in home cluster 142 although only network connection 128 is illustrated. Any node in cache cluster 132 that maintains a network connection with a node in home cluster 142 is typically called a “gateway” node.

FIG. 2 is one example of a Fileset data object (FSDO) 200 that may implement the claims subject matter. FSDO 200 includes a title section 202, which merely states the name of object 200, i.e. “FileSetObject,” an attribute section 204, which contains memory elements, or attributes, associated with FSDO 200, and a method section 206, which includes functions, or methods, that may be executed in conjunction with FSDO 200. It should be noted that the attributes and methods described are used for the purpose of illustration only. Additional and/or different attributes and methods may be employed. to implement the claimed subject matter.

Attribute section 202 includes an “FSDOID” attribute 208, a “name” attribute 210, a “status” attribute 212, a “junctionPath” attribute 214, a “rootInode” attribute 216, a “parentFS” attribute 218, a “snapShot” attribute 220, a “creationTime” attribute 222, a “numInodes” attribute 224, a “dataSize” attribute 226, an “ExpirationTimeout” attribute 228, an “expirationStatus” attribute 230 and a “comments” attribute 232. In this example, instantiations of object 200 are stored in data storage 134 (FIG. 1) in conjunction with GPFS 136 (FIG. 1) on data storage 134 of app server 132 (FIG. 1).

FSDOID attribute 208 is a variable of type FSDObjectID that contains a reference to the particular instance of object 200, or in the following example the “current fileset. Each instance of object 200 has a unique value for attribute 208 that allows each instance to be uniquely identified. Name attribute 210 is a variable of type String that stores a name for the particular dataset referenced by object 200. Status 212 is a variable of type Integer in which each bit is either set or unset to indicate the status of the files included in the corresponding fileset. JunctionPath 214 is a variable of type String that stores information of the junction path corresponding to the current fileset. RootInode 216 is a variable of type InodeID that identifies the root node of the current fileset.

ParentFS 218 is a variable of type FSOObjectID that identities a parent of the current fileset, if one exists. Snapshot 220 is a variable of type snapshotID that identifies the latest snapshop that includes the current dataset. CreationTime 222 is a variable of type Data/Time the stores a reference to the point in time that the current fileset was created. NumInodes 224 is a variable of type Integer that indicates the number of Inodes currently in use in the current fileset. DataSize 226 is a variable of type Integer that stores the size of the current dataset in kilobytes (KBs).

ExpirationTimeout 228 is a variable of type Integer that stores data representing the length of time allowable for the node storing the corresponding dataset to be out of communication with the home cluster. If this time has been exceeded, expirationStatus 230, which is a variable of type Integer, is set to indicate that the data stored by the fileset can no longer be accessed. In other words, an administrator may set expirationTimeout 228 to imply that data cannot be out of sync beyond this time after cache cluster 132 has been disconnected from home cluster 142. In the alternative, the information stored by attribute 230 may be incorporated into status attribute 212. Finally, comment 232 is a variable of type String that stores any comments an administrator may want to store in conjunction with FSDO 200.

Method section 206 of object 200 includes two exemplary functions, or methods. Only two methods are illustrated for the sake of simplicity. Those with skill in the programming arts should appreciate that an object such as object 200 would typically include many additional methods including, but not limited to, constructors, destructors, and methods to set and get values for various attributes.

An “updateFSO” method 234 is called to modify the attributes of the current fileset 200. In this example, method 234 is called with one parameter, an “updateFSO” parameter, a variable of type FSObject that stores the vales for any of the attributes that are to be set. A “setET” method 236 is called with one parameter, a “newTOValue” parameter, that indicates a value that is to be stored in ExpirationTimeout 228.

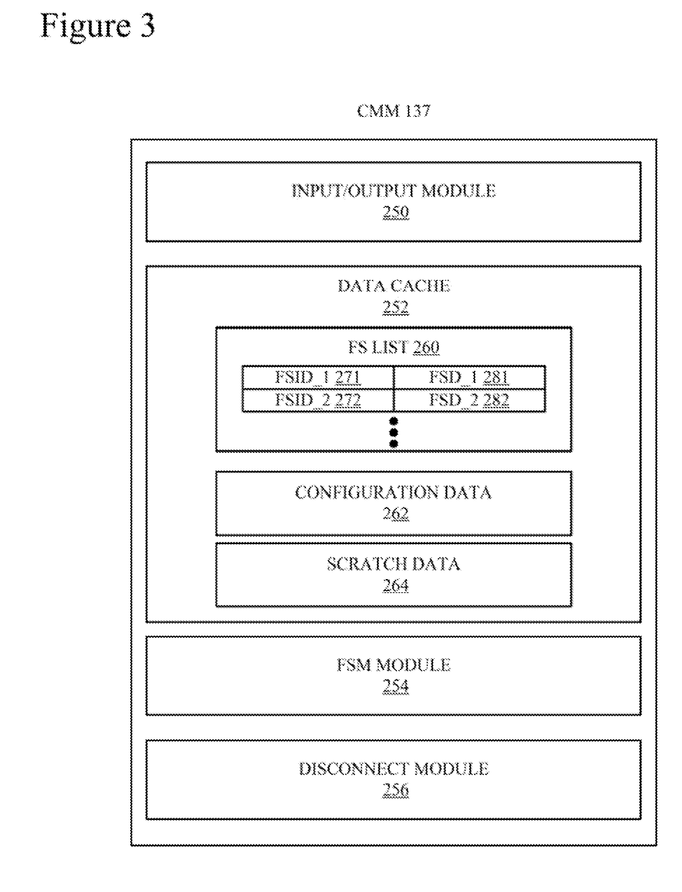

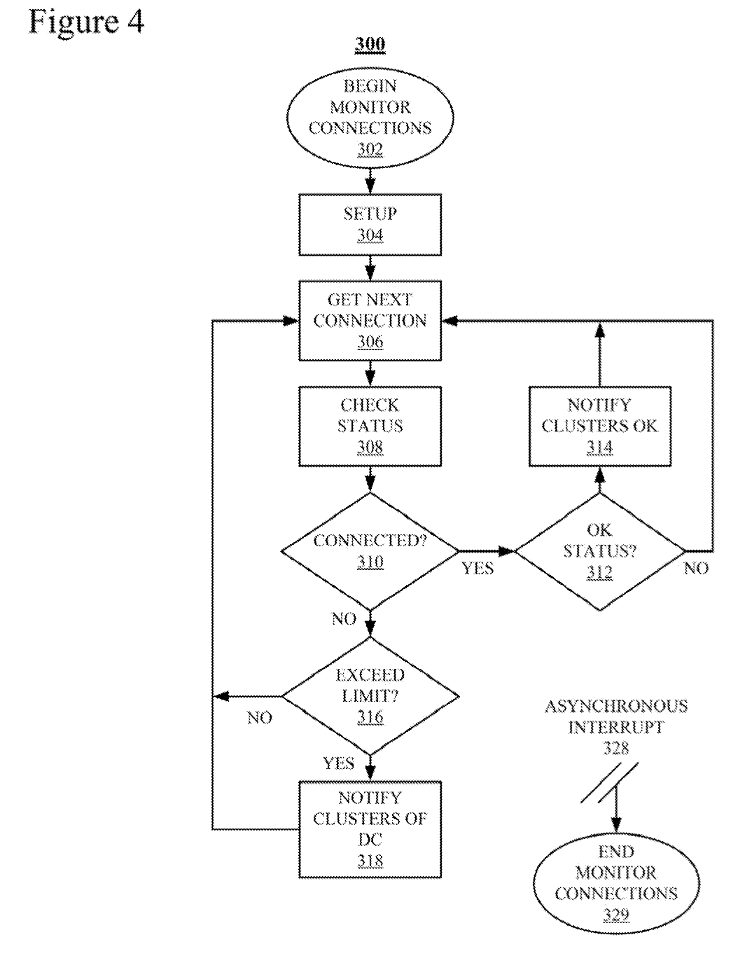

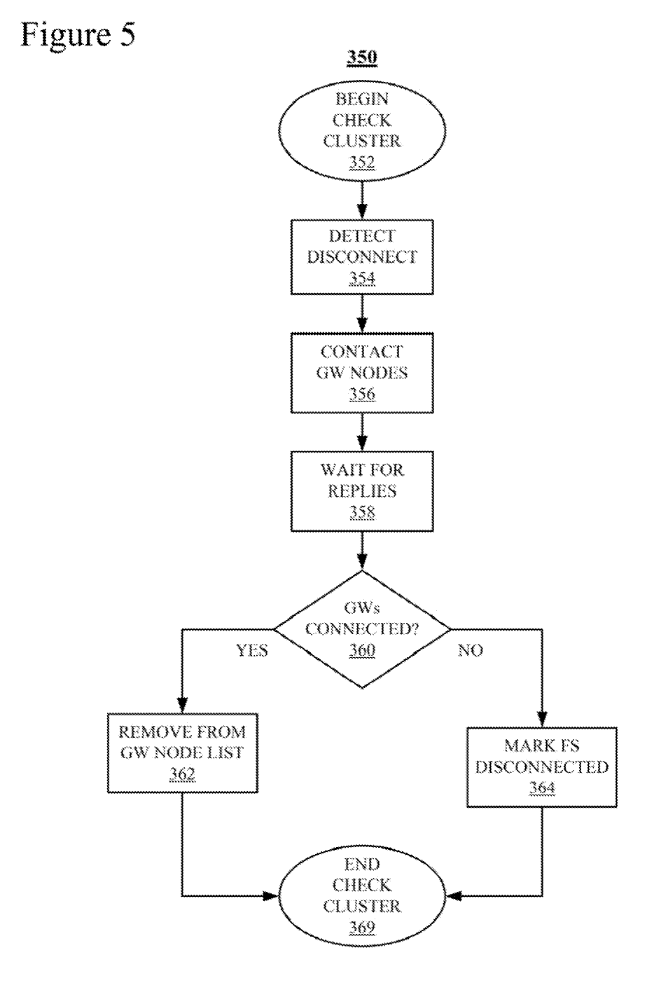

FIG. 3 is a block diagram of CMM 137, first introduced above in conjunction with FIG. 1, which may implement aspects of the claimed subject matter. In this example, CMM 137 is stored on data storage 135 (FIG. 1) of node_{—}1 134 (FIG. 1) and executes on a processor (not shown) in conjunction with GPFS 136 (FIG. 1). The modules of CMM 137 provide the functionality to implement the claimed subject matter as explained in more detail below in conjunction with FIGS. 4 and 5. CMM 137 includes an Input/Output module 250, a data cache 252, a fileset monitor (FSM) module 254 and a Disconnect module 256. It should be understood that the claimed subject matter can be implemented in many types of computing systems and data storage structures but, for the sake of simplicity, is described only in terms of node_{—}1 134 and computing system network architecture 100 (FIG. 1). Further, the representation of CMM 127 in FIG. 3 is a logical model. In other words, components 250, 252, 254 and 256 may be stored in the same or separates files and loaded and/or executed within architecture 100 either as a single system or as separate processes interacting via any available inter process communication (IPC) techniques

Input/Output module 250 handles any communication CMM 137 has with other components of architecture 100, including GPFSs such as GPFSs 136 and any other GPFSs associated with cache cluster 132. Data cache 252 is a data repository for information, including, but not limited to, listing of filesets and information on other GPFSs, that CMM 137 requires during normal operation. A FS List 260 stores information on filesets that are managed in accordance with the disclosed technology by CMM 137. Some examples of information include identifiers of specific filesets, i.e. a FSID_{—}1 271 and a FDID_{—}2 272. Also stored in conjunction with each FSID such as FSIDs 271 and 272 is data corresponding to each FSID, i.e. a FSD_{—}1 281 and a FSD_{—}2 282. For the sake of simplicity, information on only two datasets is illustrated. Examples of information include, but are not limited to, the storage locations of both the home and copies for the corresponding dataset and possible the corresponding expirationTimeout 228 (FIG. 2). A configuration data module 262 stores information that controls the operation of CMM 137, including but not limited to, time intervals for checking on connections. A scratch data module 264 provides data storage for the intermediate results of various calculations.

FSM module 254 monitors connections between different devices so that CMM 137 can detect when a connection between the location of home storage of a particular fileset and the location of corresponding copies has become compromised. Once such a issue is detected, CMM 137 initiates actions to mitigate any possible damage. Disconnect module 256 executes actions once FSM module 254 has detected a loss of connection that exceeds an expirationTimeout attribute 228 of a fileset. Operation of modules 254 and 256 is explained in more detail below in conjunction with FIG. 4.

FIG. 4 is a flowchart illustrating one example of a monitor connections process 300 that may implement the claimed subject matter. Process 300 is executed by CMM 137 (FIGS. 1 and 3). First process is configured in block 304. One connection of a plurality of connections is selected for examination during a block 306. The status of the connection is checked during a block 308. If the connection id OK, process 300 proceeds to “OK Status?” block 312. If the status is OK, i.e. the expiration status is “OK.”, control returns to block 306 and the next connection is selected. If the connection status is not OK, i.e. a connection that is up was previously down, control proceeds to a Notify Clusters OK block 314 during which cluster are notified that the appropriate filesets may be reactivated.

If, during block 310, process 300 determines a connection is not OK, filesets are examined during an Exceed Limit block 316 to determine whether or not expiration timeout attributes have been exceeded. If not, control returns to block 306. If so, during a “Notify Cluster of Disconnect (DC)” block 318, a RPC call is made to clusters so that expiration states attributes in appropriate filesets may be set to indicate that access should be prevented. Control then returns to block 306.

Since process 300 runs continuously, an asynchronous interrupt 328 is signaled to halt process 300 is an “End Monitor Connections” block 329.

FIG. 5 is a flowchart illustrating an example of a check cluster process 350 that may implement aspects of the claimed subject matter. Like process 300, in this example, process 350 is executed by CMM 137 (FIGS. 1 and 3) and provides additional functionality in the event a gateway node detects that a connection to a node in the home cache has been disconnected (see 318, FIG. 4). Process 350 starts in a “Begin Check Cluster” block 352 and proceeds immediately to a “Detect Disconnect” block 354. As explained above in conjunction with FIG. 4, a disconnect is a situation in which a gateway node, such as node_{—}1 134 (FIG. 1) in cache cluster 132, is disconnected from a home node, such as node_{—}3 144 (FIG. 1) in home cluster 142 (FIG. 1). Once a disconnection has been detected (see 300, FIG. 4), process 350 proceeds to a “Contact gateway (GW) nodes” 356 during which, in this example, node_{—}1 134 triggers a remote procedure call (RPC) to other gateway nodes in the same cluster to query as to whether or not the other nodes are also disconnected. During a “Wait for Replies” block 258, process 350 waits to the gateway node that were contacted during block 356 to respond to the query. After receiving responses form the other gateway nodes in the cluster, process 350 determines whether or not the other nodes are connected during a “GWs Connected?” block 360.

If the other nodes have maintained connections, process 350 proceeds to a “Remove From GW Node List” block 362 during which the node that initiated the query during block 356 removes itself from a gateway node list maintained by cache cluster 132. For example, a single gateway having connection problems may be due to a local network adaptor that does not affect other gateways. If during block 360, process 350 determines that other nodes are also affected, control proceeds to a “Mark Fileset (FS) Disconnected” block 364 during which the affected filed set is marked as disconnected. Finally, during an “End Check Cluster” block 369 process 350 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A system for ensuring data integrity, comprising:
a plurality of data servers, the plurality of data servers comprising:
an application server comprising a application server fileset;
a home server comprising a home server fileset; and
a first gateway server comprising a gateway fileset;
a connection monitor node (CMN) coupled to the first gateway server; and logic, executed by the CMN, for:
monitoring a connection between the home server and the application server; and
detecting the connection is disconnected and executing logic for:
comparing a duration of the connection disconnect to a expiration timeout attribute corresponding to the application server fileset; and
if the duration exceeds the expiration timeout attribute, notifying the application server to set an expiration status attribute in the application fileset.

2. The system of claim 1, the logic further comprising logic for notifying, its the duration exceeds the expiration timeout attribute, any clusters associated with the home server, the application server and the first gateway server of the detection of the disconnect.

3. The system of claim 1, wherein the plurality of data servers is configured in a general parallel file system (GPFS) configuration.

4. The system of claim 1, further comprising, upon notification to set the expiration status attribute in the application fileset, marking the application fileset as disconnected.

5. The system of claim 4, further comprising:
detecting the connection is connected; and
notifying the application server to set an expiration status attribute in the application fileset to connected.

6. The system of claim 1, further comprising:
upon notification to set the expiration status attribute in the application fileset, verifying by the first gateway server a connection status of a second gateway server; and
if the connection status of the second gateway server corresponds to a good connection, removing the first gateway server from a list of active gateway servers.

7. The system of claim 1, further comprising:
upon notification to set the expiration status attribute in the application fileset, verifying by the first gateway server a connection status of a second gateway server; and
if the connection status of the second gateway server corresponds to a had connection, marking the application fileset as disconnected.

8. A method for ensuring data integrity in a computing system, comprising:
monitoring, by a first gateway server, a connection between a home server and an application server;
detecting the connection is disconnected; and
in response to detecting the connection is disconnected:
comparing a duration of the connection disconnect to a expiration timeout attribute corresponding to a fileset corresponding to the application server; and
if the duration exceeds the expiration timeout attribute, notifying the application server to set an expiration status attribute in the fileset.

9. The method of claim 8, further comprising notifying, if the duration exceeds the expiration timeout attribute, any clusters associated with the home server, the application server and the first gateway server of the detection of the disconnect.

10. The method of claim 8, wherein the first gateway server, the home server and the application server are configured in a general parallel file system (GPFS) configuration.

11. The method of claim 8, further comprising, upon notification to set the expiration status attribute in the fileset, marking the fileset as disconnected.

12. The method of claim 11, further comprising:
detecting the connection is connected; and
notifying the application server to set an expiration status attribute in the fileset to connected.

13. The method of claim 8, further comprising:
upon notification to set the expiration status attribute in the fileset, verifying by the first gateway server a connection status of a second gateway server; and
if the connection status of the second gateway server corresponds to a good connection, removing the first gateway server from a list of active gateway servers.

14. The method of claim 8, further comprising:
upon notification to set the expiration status attribute in the fileset, verifying by the first gateway server a connection status of a second gateway server; and
if the connection status of the second gateway server corresponds to a bad connection, marking the application fileset as disconnected.

15. A computer programming product for ensuring data integrity in a computing system, comprising:
a computer-readable storage medium; and
logic, stored on the computer-readable storage medium for execution on a processor, for:
monitoring, by a first gateway server, a connection between a home server and an application server;
detecting the connection is disconnected; and
in response to detecting the connection is disconnected:
comparing a duration of the connection disconnect to a expiration timeout attribute corresponding to a fileset corresponding to the application server; and
if the duration exceeds the expiration timeout attribute, notifying the application server to set an expiration status attribute in the fileset.

16. The computer programming product of claim 15, wherein the first gateway server, the home server and the application server are configured in a general parallel file system (GPFS) configuration.

17. The computer programming product of claim 15, the logic further comprising logic for, upon notification to set the expiration status attribute in the fileset, marking the fileset as disconnected.

18. The computer programming product of claim 17, the logic further comprising logic for:
detecting the connection is connected; and
notifying the application server to set an expiration status attribute in the fileset to connected.

19. The computer programming product of claim 15, the logic further comprising logic for:
upon notification to set the expiration status attribute in the fileset, verifying by the first gateway server a connection status of a second gateway server; and
if the connection status of the second gateway server corresponds to a good connection, removing the first gateway server from a list of active gateway servers.

20. The computer programming product of claim 15, the logic further comprising logic for:
upon notification to set the expiration status attribute in the fileset, verifying by the first gateway server a connection status of a second gateway server; and
if the connection status of the second gateway server corresponds to a had connection, marking the application fileset as disconnected.
